(19) United States
(12) Patent Application Publication
(10) Pub. No.: US 2011/0212019 A1
(43) Pub. Date: Sep. 1, 2011

(54) PROCESS FOR INITIATION OF OXIDATIVE STEAM REFORMING OF METHANOL AT EVAPORATION TEMPERATURE OF AQUEOUS METHANOL

(76) Inventors: Yuh-Jeen HUANG, Hsinchu (TW); Chuin-Tih Yeh, Hsinchu (TW); Chien-Te Ho, Hsinchu (TW); Liang-Chor Chung, Hsinchu (TW)

(21) Appl. No.: 13/107,213

(22) Filed: May 13, 2011

Related U.S. Application Data
(63) Continuation-in-part of application No. 12/347,541, filed on Dec. 31, 2008.

(30) Foreign Application Priority Data
Oct. 14, 2008 (TW) 97139301

(51) Int. Cl. C01B 3/32

(52) U.S. Cl. 423/648.1

(57) ABSTRACT

A self-started OSRM (oxidative steam reforming of methanol) process at evaporation temperature of aqueous methanol for hydrogen production is disclosed. In the process, an aqueous methanol steam and oxygen are pre-mixed. The mixture is then fed to a Cu/ZnO-based catalyst to initiate an OSRM process at evaporation temperature of aqueous methanol. The temperature of the catalyst bed, with suitable thermal isolation, may be raised automatically by the exothermic OSRM to enhance the conversion of methanol.

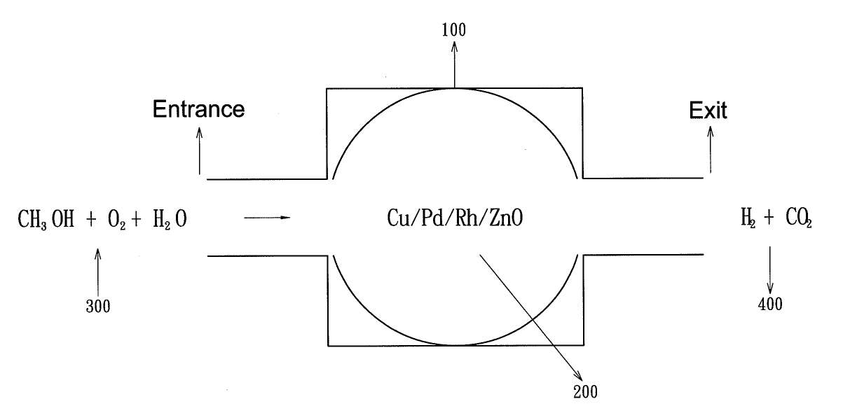

### RELATED APPLICATIONS

This application is a Continuation-In-Part patent application Ser. No. 12/347,541 filed on Dec. 31, 2008, currently pending.

### BACKGROUND OF THE INVENTION

1. Field of the Invention

The present invention relates to a method for generating hydrogen, and particularly to a self-started OSRM process at evaporation temperature of aqueous methanol for hydrogen production.

2. Description of the Prior Art

Fuel cells capable of converting chemical energy of the fuel into electricity and also satisfying the requirement of environmental protection are now being continuously developed. Hydrogen fuel cells (HFC) take advantage of lower operation temperature and are of great potential among those developing fuel cells. However, HFCs have disadvantages in storage and transportation of hydrogen. Hydrocarbon molecules are used as the external primary fuel in PEMFCs and converted into hydrogen rich gas (HRG) on site. HRG is gas mixture with high hydrogen content and one of environmentally friendly fuels applied in fuel cells.

Production of HRG from reforming of methanol has been widely studied because it is highly chemically active, abundant, and cheap. Many methanol reforming processes have been developed and published in literatures, for example, (1) “steam reforming of methanol” (SRM) and (2) “partial oxidation of methanol” (POM), which may be expressed by the following chemical formulas.

CH₃OH+H₂O→3H₂+CO₂ ΔH=49 kJ mol⁻¹ (1)

CH₃OH+½O₂→2H₂+CO₂ ΔH=−192 kJ mol⁻¹ (2)

Reaction SRM has a high hydrogen yield (number of hydrogen molecule produced from each consumed methanol molecule) of R_{H2}=3.0. However, SRM is an endothermic reaction which is not theoretically favored at low temperatures. According to Le Chatelier's Principle, SRM becomes efficient at high temperatures.

Comparatively, exothermic POM is favored at lower temperatures. However, compared to SRM theoretical value of R_{H2}=3.0, a lower hydrogen yield of R_{H2}=2.0, is produced.

A more advanced process is called “oxidative steam reforming of methanol” (OSRM). OSRM uses a mixture of water vapor and oxygen as oxidant. In other words, it is a combination of reactions (1) and (2) in an optional ratio. Theoretically, negligible reaction heat may occur at ratio 3.9/1. On one hand, a desirably high R_{H2} (about 2.75) may be generated by adding steam, and on the other hand, the CO content in HRG and the reaction temperature can be decreased due to the presence of oxygen in the OSRM reaction.

There are many OSRM-related prior art references. Some use supported copper catalysts such as Cu/ZnO—Al₂O₃ and Cu/ZrO₂, as disclosed in WO publication No. 2004/083116 belonging to Schlogl et al., for example. The Cu—Al alloy and transition metal catalyst (containing no copper) disclosed in WO publication No. 2005/009612 A1 belonging to Tsai et al improves the stability of copper catalyst and lowers the cost; however, the reaction has to be initiated at a reaction temperature of T_{R}>240° C. Furthermore, US publication No. 2006/0111457 A1 belonging to C H Lee et al adopts Pt/CeO₂—ZrO₂ catalysts instead of conventional Cu/ZnO—Al₂O₃ catalysts to improve stability; however, the reaction still has to be initiated at a reaction temperature of T_{R}>300° C. Some use Pd/CeO₂—ZrO₂ catalyst, as disclosed in US publication No. 2001/0021469 A1 and 2001/0016188 A1 belonging to Kaneko et al. and Haga et al., or Pd—Cu/ZnO alloy catalyst, as disclosed in WO published patent 96/00186 belonging to Edwards et al. These catalysts require a reaction temperature of T_{R}>200° C. to catalyze OSRM and the selectivity of CO in HRG is high (S_{co}>2). If copper catalyst dispersed on mixed zinc, aluminum and zirconium oxide is used, the CO selectivity may be decreased to S_{co}<1% (US publication No. 2005/0002858 belonging to Suzuki et al.), but a T_{R}>200° is still required. The gold catalyst disclosed in US publication No. 2006269469 belonging to Yeh et al. may catalyze methanol at reaction temperature T_{R}=150° C. to generate HRG with low S_{co}. However these OSRM process can not be initiated at room temperature and need external heat to initiate the hydrogen generating reaction.

Table 1 shows the comparisons of different catalyst systems for the OSRM disclosed in other known references. It is observed that all of the catalyst systems require a temperature of T_{R}>200° C. to effectively catalyze the OSRM.

TABLE 1
Comparison of different catalyst system for the OSRM

| Catalyst | | | | | | | |
|---|---|---|---|---|---|---|---|
| System | x | w | T_{R}(° C.) | C_{MeOH} | R_{H2} | S_{CO} % | Reference |
| Cu/CeO₂ | 0.83 | 0.15 | 230 | 85 | ~ | 3 | Perez- |
| | | | | | | | Hernandez ⁽¹⁾ |
| CuZn | 0.12 | 0.11 | 200 | 90 | ~ | 1.7 | Shishido ⁽²⁾ |
| CuZnAlZr | 0.3 | 1.3 | 227 | 80 | 2.8 | 0.7 | Velu ⁽³⁾ |
| CuZnAl | 0.47 | 1.43 | 227 | 100 | 2.45 | 0.19 | Shen ⁽⁴⁾ |
| CuZnZrCe | 0.25 | 1.6 | 227 | 78.5 | 2.9 | 0.58 | Velu ⁽⁵⁾ |
| Pd/ZnO | 0.05 | 0.1 | 220 | 90 | ~ | 3 | Iwasa ⁽⁶⁾ |
| PdZnAl | 0.09 | 1.1 | 300 | 48 | ~ | 13 | Lenarda ⁽⁷⁾ |
| Pd/ZnO | 0.1 | 1.5 | 247 | 74 | — | 4 | Liu ⁽⁸⁾ |

Remarks: x represents oxygen/methanol, and w represents water/methanol. The references as listed below:
⁽¹⁾ Perez-Hernandez, R., Gutierrez-Martinez, A., Gutierrez-Wing, C.E., Int. J. Hydrogen Energy. 32, 2888-2894 (2007);
⁽²⁾ Tetsuya Shishido, Yoshihiro Yamamotob, Hiroyuki Morioka, Katsuomi Takehira., J. Mol. Catal. A: Chem. 268, 185-194 (2007);
⁽³⁾ Velu, S., Suzuki, K., Kapoor, M. P., Ohashi, F., and Osaki, T., Appl. Catal. A: 213, 47 (2001);
⁽⁴⁾ Shen, J-P., and Song C., Catal. Today 77, 89 (2002);
⁽⁵⁾ Velu, S., and Suzuki, K., Topics in Catal. 22, 235 (2003);
⁽⁶⁾ Nobuhiro Iwasa, Masayoshi Yoshikawa, Wataru Nomura, Masahiko Arai., Appl. Catal., A 292, 215-222(2005)
⁽⁷⁾ Lenarda, M., Storaro, L., Frattini, R., Casagrande, M., Marchiori, M., Capannelli, G., Uliana, C., Ferrari, F., Ganzerla, R., Catal. Commun. 8, 467-470 (2007)
⁽⁸⁾ Liu, S., Takahashi, K., and Ayabe, M., Catal. Today 87, 247 (2003).

The gold catalyst disclosed in US publication No. 2006269469 belonging to Yeh et al. may catalyze methanol at reaction temperature T_{R}=150° C. to generate HRG with low S_{co}. However, the initial temperature (pre-heating temperature) is 120° C., these OSRM processes can not be initiated at evaporation temperature of aqueous methanol (<100° C.) and external heat is needed to initiate the hydrogen generating reaction.

To sum up, a self-started OSRM process at low temperature (<100° C.) to obtain low S_{co} and high R_{H2} for hydrogen at T_{R}<200° C. is highly desired.

### SUMMARY OF THE INVENTION

The present invention is directed to provide a OSRM process for hydrogen process initiated at low temperature (<100° C.).

The present invention is also directed to provide a self-started OSRM process at evaporation temperature of aqueous methanol for hydrogen production, wherein no external heat is required for initiating the OSRM process, and the generated hydrogen could be applied in fuel cells.

The OSRM process self-started at evaporation temperature of aqueous methanol for hydrogen production according to an embodiment includes the following steps. An aqueous methanol steam and oxygen is pre-mixed to obtain a mixture. The mixture is fed to a fixed-bed reactor with a reactor temperature lower than 100° C., wherein the Cu/ZnO-based catalyst, a CuPd/ZnO catalyst or a CuRh/ZnO catalyst. An exothermic OSRM process is initiated at evaporation temperature of aqueous methanol and the temperature of the mixture is raised. Hydrogen is measured at a reaction temperature between 140° C. and 200° C., wherein the hydrogen contains smaller than or equal to 1% CO by mole.

The catalyst used in the self-started OSRM process at evaporation temperature of aqueous methanol for hydrogen production according to an embodiment is disclosed. The catalyst includes a Cu/ZnO-based catalyst comprising a CuPd/ZnO catalyst or a CuRh/ZnO catalyst, wherein the Cu/ZnO-based catalyst is a supported copper catalyst prepared with a co-precipitation method, a Cu content in the Cu/ZnO-based catalyst is between about 10% and about 35% (w/w), and a ZnO content in the Cu/ZnO catalyst is greater than about 60.0% (w/w).

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

The FIGURE is a schematic diagram illustrating an embodiment of the present invention.

### DESCRIPTION OF THE PREFERRED EMBODIMENT

The present invention catalyzes an OSRM (oxidative steam reforming of methanol) process to generate a HRG (hydrogen rich gas) by taking advantage of a supported CuPd/ZnO catalyst or a supported CuRh/ZnO catalyst to initiate the OSRM at temperature lower than 100° C. The catalysts may achieve higher methanol conversion rate (C_{MeoH}) and lower CO selectivity (S_{CO}) at a lower reaction temperature (T_{R}≦200° C.), where reaction temperature stands for the reactor temperature during OSRM process. The small amount of Cu and Pd or Rh particles are evenly distributed on a suitable support and provide good catalytic activity of the CuPd/ZnO or CuRh/ZnO catalyst.

### Preparation of Catalyst

The supported Cu/ZnO-based catalyst used in the present invention is generally prepared with a co-precipitation method. In one example, a 70° C. mixture solution containing Cu(NO₃)₂, Pd(NO₃)₂, and Zn(NO₃)₂ is added to 1M NaHCO₃ solution, and the pH value for the co-precipitation method is adjusted between 6 and 9 to generate a dark colored precipitate. The precipitate is then dried at 100° C. and calcined at 400° C. to obtain a fresh Cu/PdxZnO-y catalyst (in which x represents the percentage of oxidized Pd (w/w), and y represents the pH value of precipitation). The Cu content in the CuPd/ZnO catalyst prepared with the above co-precipitation method may vary from 10% to 35%.

### OSRM Process System and Method for Testing Catalytic Reaction

FIGURE illustrates an OSRM process system for hydrogen production based on a self-started OSRM process at evaporation temperature of aqueous methanol according to one embodiment of the present invention. A 0.1 g reduced catalyst sample (60˜80 mesh) is placed in a quartz tube with 4 mm inner diameter in which the catalyst is immobilized with silica wool in a fixed bed reactor or a thermally-insulated reactor 100. With regard to reacting gases, an aqueous methanol is evaporated with a pre-heater at a flow rate controlled by a liquid pump to obtain an aqueous methanol steam. Each flow rate of oxygen and carrier gas (e.g. Ar) is respectively controlled by a flow mass controller. The oxygen, Ar, and the aqueous methanol steam evaporated from the aqueous methanol are charged into a mixing chamber and mixed homogeneously (2.89% O₂, 15.02% H₂O, 11.56% CH₃OH, 70.53% Ar; nH₂O/nMeOH=1.3, nO₂/nMeOH=0.5) to obtain a mixture. The mixture (reactant 300) is then fed to a catalyst bed 200 in the thermally-insulated reactor 100 to generate product 400.

The product 400 is then subjected to a qualitative separation process via two GC (gas chromatography), in which the H₂ and CO are separated by a Molecular Sieve 5A chromatography column, and H₂O, CO₂, and CH₃OH are separated by a Porapak Q chromatography column, and a quantitative analysis carried out by a TCD (thermal conductivity detector).

After the quantitative analysis via TCD, a methanol conversion rate (C_{MeOH}) and CO selectivity (S_{CO}) are calculated as follows:

C_{MeOH}=(n_{MeoH,in}−n_{MeOH,out})/n_{MeOH,in}×100%

S_{CO}=n_{CO}/(n_{CO2}+n_{CO})×100%

R_{H2}=n_{H2}/(n_{MeOH,in}−n_{MeOH,out}).

A higher C_{MeOH} in the OSRM process represents the higher amount of reacted methanol in the whole process. The hydrogen may be generated from the OSRM process as well as oxidized with the oxygen in the reacting gases. A higher S_{CO} represents that the carbon in the methanol is more likely desorbed in way of CO after the methanol is dehydrogenated; that is to say a less selectivity of CO₂.

### OSRM Process System and Method for Testing Catalytic Reaction

The test is performed by feeding the mixture to 100 mg catalyst sample at a fixed flow rate (1.2 ml/hr) in the fixed-bed reactor. A water/methanol molar ratio (w) in the aqueous methanol is controlled by a liquid feeding pump. An oxygen/methanol molar ratio (x) is controlled regulating a flow rate of the oxygen. A flow rate for overall reactant feeding is controlled to 100 ml/min via the carrier gas Ar. The contact time for the process is thus fixed approximately to W_{cat}/F=1×10⁻³ min g ml⁻¹.

The reactant is evaporated using a pre-heater before being directed into the reactor with reactor temperature=90° C. All catalysts applied in the process are activated with hydrogen reduction for 1 hour at 200° C. before the process and then applied. The experimental outcomes in the presence of different variants are listed in Table 2.

TABLE 2
Different catalysts on the outcomes of OSRM process

| | | Wt_{Pd} % | | | | | | | | | |
|---|---|---|---|---|---|---|---|---|---|---|---|
| | Catalyst | or | | | Tᵢ | T_{R} | C_{MeOH} | | S_{CO} | CO | CO |
| No. | System | Wt_{Rh} % | x | w | *(° C.) | (° C.) | (%) | R_{H2} | (%) | (mole %) | (ppm) |
| 1 | Cu₃₀/ZnO | 0 | 0.25 | 1.3 | >187 | 190 | 40 | 1.6 | 3.2 | 0.48 | 4817 |
| 2 | Cu₃₀Pd₂/ZnO | 2.12 | 0.25 | 1 | 90 | 170 | 76 | 2.6 | 9.5 | 3.08 | 30792 |
| 3 | Cu₃₀Pd₂/ZnO | 2.12 | 0.25 | 1 | 90 | 190 | 91 | 2.6 | 10.1 | 2.23 | 22279 |
| 4 | Cu₃₀Pd₂/ZnO | 2.12 | 0.25 | 1.3 | 90 | 170 | 57 | 2.0 | 2.0 | 1.97 | 19708 |
| 5 | Cu₃₀Pd₂/ZnO | 2.12 | 0.25 | 1.3 | 90 | 190 | 68 | 2.4 | 2.2 | 0.37 | 3683 |
| 6 | Cu₃₀Pd₂/ZnO | 2.12 | 0.25 | 1.5 | 90 | 170 | 60 | 2.3 | 3.2 | 0.51 | 5093 |
| 7 | Cu₃₀Pd₂/ZnO | 2.12 | 0.25 | 1.5 | 90 | 190 | 78 | 2.5 | 3.8 | 0.68 | 6799 |
| 8 | Cu₃₀Rh₂/ZnO | 1.51 | 0.25 | 1.3 | 90 | 170 | 31 | 1.7 | 1.7 | 0.52 | 5206 |
| 9 | Cu₃₀Rh₂/ZnO | 1.51 | 0.25 | 1.3 | 90 | 190 | 42 | 1.8 | 1.9 | 0.65 | 6527 |
| 10 | Cu₃₀Pd₂/ZnO | 2.12 | 0.1 | 1.3 | N/A | 170 | 31 | 1.8 | 2.6 | 0.26 | 2630 |
| 11 | Cu₃₀Pd₂/ZnO | 2.12 | 0.1 | 1.3 | N/A | 190 | 40 | 2.3 | 2.0 | 0.27 | 2727 |
| 12 | Cu₃₀Pd₂/ZnO | 2.12 | 0.5 | 1.3 | 90 | 170 | 93 | 2.3 | 2.5 | 0.58 | 5758 |
| 13 | Cu₃₀Pd₂/ZnO | 2.12 | 0.5 | 1.3 | 90 | 190 | 94 | 2.4 | 2.9 | 0.60 | 6039 |
| 14 | Cu₃₀Pd₂/ZnO | 2.12 | 0.5 | 1.3 | 90 | 140 | 97 | 2.1 | 2.5 | 0.82 | 8229 |
| 15 | Cu₃₀Pd₂/ZnO | 2.12 | 0.6 | 1.3 | 90 | 170 | 87 | 1.3 | 3.2 | 0.89 | 8948 |

Remarks: Tᵢ stands for initiation temperature.

Influence of Adding Rh and Pd into the Cu/ZnO-Based Catalyst

The experiment 1 in the Table 2 is performed with Cu/ZnO-based catalyst without Pd loading under the condition of x=0.25 and w=1.3. It shows that C_{MeOH} is lower than 40% when the reaction temperature is lower than 190° C. and the reaction couldn't be initiated at initial temperature=90° C. In addition, the Cu/ZnO-based catalyst with Pd loading could initiate the process at initial temperature=90° C. according to experiment 2 to 7. In another example, another transition metal, Rh, with the same 4d orbital is applied to form a CuRh/ZnO catalyst for catalyzing the process.

### Influence of Water/Methanol Molar Ratio on OSRM Process

The water/methanol molar ratios (w) are varied to determine the influence of water/methanol molar ratio on the C_{MeOH}, R_{H2} and S_{CO} in the CuPd/ZnO-catalyzed OSRM process according to the experiments 1 to 7 in Table 2 in which the reaction temperature is set at 170° C. or 190° C. Here, a Cu₃₀Pd₂ZnO catalyst which contains 2% Pd is applied, and the oxygen/methanol molar ratio (x) is fixed to 0.25.

In comparison with experiment 3, 5 and 7 where x=0.25, S_{CO} reaches 10% when w=1.0 and reaches 3% when w=1.5.

### Influence of Oxygen/Methanol Molar Ratio on the OSRM Process

The molar ratios of oxygen to methanol (x) are varied to determine the influence of oxygen/methanol molar ratio on the C_{MeOH}, R_{H2} and S_{CO} in the CuPd/ZnO-catalyzed OSRM process according to the experiments 4, 5 and 10 to 13 in Table 2 in which the reaction temperature is set at 170° C. or 190° C. Here, a Cu₃₀Pd₂ZnO catalyst which contains 2% Pd is applied, and the water/methanol molar ratio (w) is fixed to 1.3.

The outcome shows when x is equal to or smaller than 0.1, the processes tend to be endothermic SRM (steam reforming of methanol) processes and can not be initiated at evaporation temperature of aqueous methanol even in the presence of Pd-containing Cu/ZnO-based catalyst. When x=0.25 or x=0.5, the process can be initiated at initial temperature=90° C. with the assistance of exothermic POM (partial oxidation of methanol), and the C_{MeOH} increases as the oxygen/methanol molar ratio increases. In addition, R_{H2} also increases as the oxygen/methanol molar ratio increases. That is to say a proper oxygen/methanol molar ratio may contribute to the optimization R_{H2} of methanol. As mentioned above, redundant CO would poison the platinum electrodes; however, it shows no significant S_{CO} variation (2%˜3%), in which the S_{CO} at x=0.5 is greater than the S_{CO} at x=0.1, and the S_{CO} at x=0.1 is greater than the S_{CO} at x=0.25. According to experiment 14, at x=0.5 and w=1.3, the reaction temperature for OSRM process is 140° C., the C_{MeOH} is 97%, and S_{CO} is 2.5% though with relatively low R_{H2}. Here, it should be noted that this OSRM process may be initiated at evaporation temperature of aqueous methanol and reach the reaction temperature. In case of x=0.6 (experiment 15), the R_{H2} at 170° C. is much lower than 2, and the process would be initiated and reach the reaction temperature of 170° C. It shows that the process is prone to POM and completely oxidized methanol in this state; x=0.5 is thus the preferred option in consideration of the influence of initiation temperature on R_{H2}.

A self-started OSRM process at evaporation temperature of aqueous methanol for hydrogen production according to an embodiment includes the following steps. An aqueous methanol and oxygen is pre-mixed to obtain a mixture. The mixture is fed to a Cu/ZnO-based catalyst at reactor temperature lower than 100° C., wherein the Cu/ZnO-based catalyst includes a CuPd/ZnO catalyst or a CuRh/ZnO catalyst. An OSRM process is catalyzed and raises the temperature of the catalyst bed. Hydrogen is yielded at a reaction temperature substantially between 140° C. and 200° C., wherein the hydrogen contains substantially smaller than or equal to 1% CO by mole.

The catalysts used in a self-started OSRM process at evaporation temperature of aqueous methanol for hydrogen production according to an embodiment are disclosed. The catalysts include a Cu/ZnO-based catalyst comprising a CuPd/ZnO catalyst or a CuRh/ZnO catalyst, wherein the Cu/ZnO-based catalyst is a supported copper catalyst prepared with a co-precipitation method, the Cu content in the Cu/ZnO-based catalyst is substantially between about 10% and about 35% (w/w), and the ZnO content in the Cu/ZnO-based catalyst is substantially greater than about 60.0% (w/w).

To sum up, the present invention provides a self-started OSRM process at evaporation temperature of aqueous methanol for hydrogen production and a catalyst thereof. Firstly, an aqueous methanol and oxygen is pre-mixed to obtain a mixture, wherein a water/methanol molar ratio in the aqueous methanol is in a range between 1 and 1.5 and an oxygen/methanol molar ratio in the mixture is smaller than or equal to 0.5. The mixture is fed to a Cu/ZnO-based catalyst at evaporation temperature of aqueous methanol for an OSRM process to be catalyzed. The temperature is spontaneously raised to the reaction temperature by OSRM process wherein no external heat other than aqueous methanol evaporation is required for initiating the OSRM process. Ideal values of C_{MeOH} and R_{H2} are then obtained.

According to a preferred example, the oxygen is provided with pure oxygen or air. The catalyst includes Cu particles on a support containing ZnO, wherein the Cu content is substantially between 10% and 35% (w/w), and the diameter of CuO is smaller than or equal to 5 nm. The Pd content is substantially between 1% and 4% (w/w), and the diameter of PdO is smaller than or equal to 10 nm.

The reaction temperature for OSRM process may be set at about 140° C. and therefore compliant with the operating temperature of hydrogen fuel cells. Further, the present invention initiates the OSRM process at evaporation temperature of aqueous methanol at temperature lower than 100° C. and raises the temperature to the reaction temperature between 140° C. and 200° C. without requiring any external heat supply. Thus, the energy supply and start-up time in the hydrogen reformer is greatly decreased, and higher C_{MeOH} as well as R_{H2} is then achieved.

The application of present invention may influence the development of petroleum industry, fuel cell, and hydrogen economics. For example, the CuPd/ZnO catalyst of the present invention which catalyzes the OSRM process at evaporation temperature of aqueous methanol to obtain high-yielding hydrogen may be applied in proton exchange membrane fuel cells which will be the potential power supply for notebooks, cellular phones, and digital camera.

To sum up, the CuPd/ZnO catalyst of the present invention plays an important role in the exemplified self-started OSRM process at evaporation temperature of aqueous methanol for hydrogen production. The CuPd/ZnO catalyst enables the initiation of the OSRM process at evaporation temperature of aqueous methanol and lower reaction temperature (T_{R}≈140° C.) of the OSRM process. Thus, the energy supply and start-up time in the hydrogen reformer is greatly decreased, and higher C_{MeOH} as well as R_{H2} is then achieved.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A self-started OSRM process at evaporation temperature of aqueous methanol for hydrogen production, comprising:
pre-mixing an aqueous methanol steam and oxygen to obtain a mixture;
feeding the mixture to a Cu/ZnO-based catalyst in an OSRM reactor with a reactor temperature lower than 100° C., wherein the Cu/ZnO-based catalyst comprises a CuPd/ZnO catalyst or a CuRh/ZnO catalyst;
catalyzing an OSRM (oxidative steam reforming of methanol) process whereby the reactor temperature is raised; and
yielding hydrogen at the reactor temperature substantially between 140° C. and 200° C. during the OSRM process, wherein the hydrogen contains substantially smaller than or equal to 1% CO by mole.

2. The self-started OSRM process as claimed in claim 1, wherein the Cu/Pd (w/w) ratio or Cu/Rh (w/w) ratio is greater than 6.4.

3. The self-started OSRM process as claimed in claim 1, wherein the oxygen is provided with pure oxygen or air.

4. The self-started OSRM process as claimed in claim 1, wherein a water/methanol molar ratio in the aqueous methanol substantially is 1 to 1.5.

5. The self-started OSRM process as claimed in claim 1, wherein an oxygen/methanol molar ratio in the mixture is substantially smaller than or equal to 0.5.

6. The self-started OSRM process as claimed in claim 1, wherein the Cu/ZnO-based catalyst comprises a supported copper catalyst prepared with a co-precipitation method.

7. The self-started OSRM process as claimed in claim 6, wherein a precipitating agent used in the co-precipitation method includes a NaHCO₃ solution.

8. The self-started OSRM process as claimed in claim 6, wherein a pH value for the co-precipitation method is between 6 and 9.

9. The self-started OSRM process as claimed in claim 1, wherein the Cu content in the Cu/ZnO-based catalyst is substantially between 10% and 35% (w/w).

10. The self-started OSRM process as claimed in claim 1, wherein the ZnO content in the Cu/ZnO-based catalyst is substantially greater than 60.0% (w/w).

11. The self-started OSRM process as claimed in claim 1, wherein the Cu/ZnO-based catalyst comprises a CuPd/ZnO catalyst.

12. The self-started OSRM process as claimed in claim 1, wherein the Pd content in the Cu/ZnO-based catalyst is substantially between 1% and 4% (w/w).

13. The self-started OSRM process as claimed in claim 1, wherein no external heat other than aqueous methanol evaporation is required for initiating the OSRM process.
